(19) United States
(12) Patent Application Publication
(10) Pub. No.: US 2008/0297513 A1
(43) Pub. Date: Dec. 4, 2008

(54) Method of Analyzing Data

(75) Inventors: Stewart Ellis Smith Greenhill, Hilton (AU); Svetha Venkatesh, Winthrop (AU); Peter Leslie Lee, Wattle Park (AU); Geoffrey Alec William West, Kalamunda (AU); Chiou Peng Lam, Karawara (AU)

Correspondence Address: EDELL, SHAPIRO & FINNAN, LLC, 1901 RESEARCH BOULEVARD, SUITE 400, ROCKVILLE, MD, 20850, US

(73) Assignee: IPOM PTY LTD, Bentley (AU)

(21) Appl. No.: 12/102,502

(22) Filed: Apr. 14, 2008

Related U.S. Application Data
(63) Continuation of application No. PCT/AU2005/001595, filed on Oct. 14, 2005.

(51) Int. Cl. G06T 11/20; G09G 5/02; G06F 3/048

(52) U.S. Cl. 345/440; 345/589; 715/771

(57) ABSTRACT

A computer assisted method of analysis suitable for process control, comprises the steps of: receiving first data streams representing values from a process; receiving second data streams representing states of the process; recording metadata about the data streams; calculating relationships between pairs of the data streams; and recording relationship data resulting from the calculating step together with an association between at least one relationship datum and its corresponding meta-data.

### CROSS REFERENCE TO RELATED APPLICATIONS

This application is a continuation of International Application No. PCT/AU2005/001595, filed on Oct. 14, 2005, entitled “Method of Analysing Data,” which claims priority under 35 U.S.C. § 119 to Application No. AU 2004905955 filed on Oct. 15, 2004, entitled “Method of Analysing Data,” the entire contents of which are hereby incorporated by reference.

### FIELD OF THE INVENTION

This invention concerns a computer assisted method of analysis suitable for process control. In further aspects the invention concerns a computer system for performing the method and computer software for performing the method. The invention has particular utility in the control of Industrial Processes.

### BACKGROUND

Industrial processes involve large and complex systems. Typically, an industrial process involves many thousands of variables which are controlled in part by automatic processes, and in part by human operators. In the operation of these processes large amounts of information are collected by process control and monitoring systems.

Most tools currently available for process analysis are complex mathematical analysis tools that are general in nature, require an understanding of their language, and are expensive and time consuming to use. Tools such as Matlab, Excel, or Mathcad are routinely used in process engineering environments. However, they require that the data all be stored in memory, limiting the complexity of the problems that can be analyzed or visualized.

### SUMMARY

The invention is a computer assisted method of analysis suitable for process control, comprising the steps of:

receiving first data streams representing values from a process;

receiving second data streams representing states of the process;

recording metadata about the data streams;

calculating relationships between pairs of the data streams; and

recording relationship data resulting from the calculating step together with an association between at least one relationship datum and its corresponding meta-data.

By recording relationship data between the data streams together with corresponding metadata the process engineer is able to gain insight about the process and its control in relation to aspects of the process described by the metadata.

The data streams may be continuous streams, or they may be discontinuous, discontiguous or even a succession of blocks of data.

The values of the first data streams may be measurements from the process. The values of the first data streams may be sampled over time. The states of the second data streams may be events or conditions in the process.

There may be one or more third data streams representing statistics calculated from the first or second data streams, or both.

The metadata may concern the origins of the data streams, for instance it may comprise tags that identify the location of origin of each respective data stream. The association may link each datum to its respective locations of origin. There may be more than one location depending on the origins of the data streams. The meta-data may include flow charts or plant diagrams. The chart or diagram may display the value of each datum at the location of its source.

The calculating step may involve calculating correlations of the data streams. The calculating step may involve calculating, for a range of different time lags, autocorrelations of the data streams. Alternatively, or in addition the calculating step may involve calculating, for a range of different time lags, cross-correlation of pairs of data streams.

Sub-sets may be created within the relationship data, and each sub-set may comprise data having a value within the same predetermined range of values. For instance, each sub-set may comprise data having a correlation value within the same predetermined range of values. Where the metadata involves tags that label the locations of origins a sub-set is designated a ‘tag group’.

The predetermined range of values is a user selectable parameter, so for instance the user may select a sub-group, or tag group, made up of data streams that are correlated to better than 90%. The degree of correlation may be changed by the user and this may automatically flow through to a change in the composition of the group. A similar result may automatically be achieved when making other changes, such as changing the amount of lag in correlation.

As time passes and more data is received, the calculating step may be performed again to update the relationship data. The step may even be performed repeatedly in real time.

The relationship data may be displayed in a first form as a matrix with a single datum in each cell of the matrix. The relationship data calculated for each data stream will appear in both a row and a column of the matrix. The matrix may be convertible directly to raster.

The rows and columns may be grouped according to the value of the relationship data, in other words the tag groups may automatically be collected together.

The relationship data may be displayed in a second form as a diagram of metadata having locations marked according to their corresponding relationship datum. The location of the source of each data stream, may be indicated in the diagram of metadata.

The relationship data may be displayed in a third form as a list.

The data streams may also be displayed in the form of time-series data.

Historical values of the relationship data or data streams may be displayed.

Correlations between a pair of data streams may be displayed as a function of lagged time.

Coding may be used to identify different sub-sets in the display, and this coding may survive when a different view is selected so that a tag group highlighted in one group is still highlighted when the view is changed. The coding may be color coding or shading. A user may be able to select a sub-set by:

clicking on a cell in the matrix;

clicking on a marked location in the meta-data diagram; or,

clicking on a datum in the list.

A neural network may be trained to model the state space of the process.

In another aspect the invention is a computer system for performing the method.

A further aspect of the invention is computer software for performing the method.

In the claims of this application and in the description of the invention, except where the context requires otherwise due to express language or necessary implication, the words “comprise” or variations such as “comprises” or “comprising” are used in an inclusive sense, i.e. to specify the presence of the stated features but not to preclude the presence or addition of further features in various embodiments of the invention.

### BRIEF DESCRIPTION OF THE DRAWINGS

In order to provide a better understanding of the present invention preferred embodiments will be described below, by way of example only, with reference to the accompanying drawings, in which:

FIG. 1 is a schematic view of information flow between parts of an embodiment of the present invention.

FIG. 2 is a large scale visualization of a cross-correlation matrix (717×717 variables).

FIG. 3 is a small scale visualization of the cross-correlation matrix of FIG. 2 (approx 40×40 variables).

FIG. 4 is a process view showing tag grouping. The selected tag is displayed as a filled square. The related tags are displayed as filled circles.

FIG. 5 is a process view showing tag similarity. The selected tag is displayed as a filled square. Other tags are displayed as filled circles, with the shading indicating the degree of correlation according to the currently defined shading mapping.

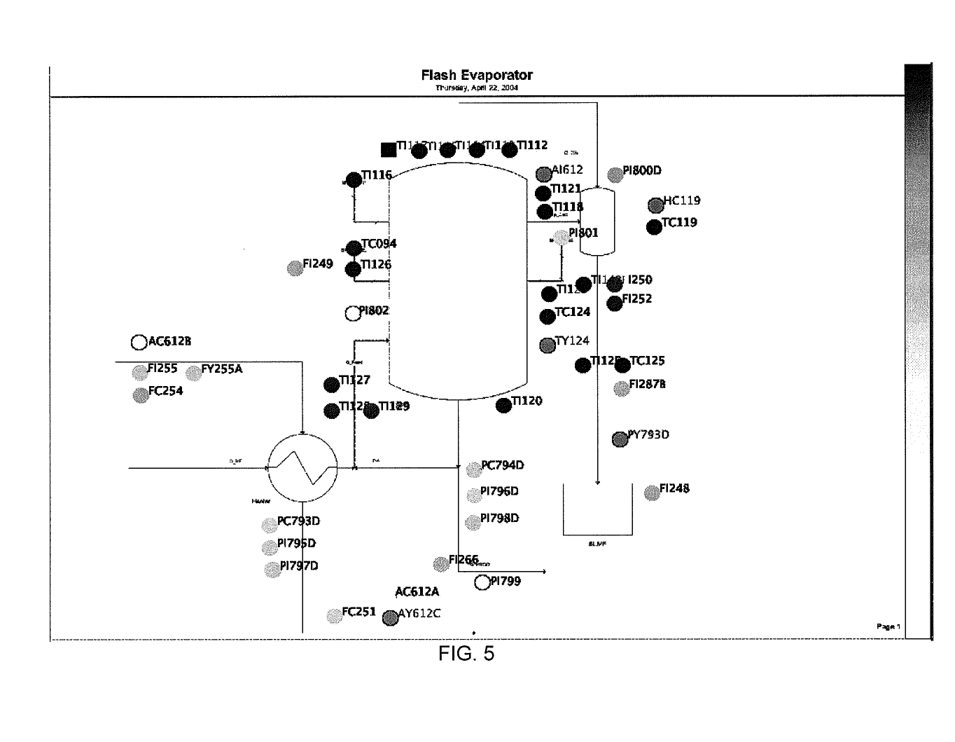

FIG. 6 is a signal view showing changes over time for process variables and alarms in a tag group.

FIG. 7 is a signal view showing signal amplitude using shading rather than plotting on the vertical axis. This is useful for visually identifying patterns in large sets of tags.

FIG. 8 is a signal view showing a small set of variables with scale information.

FIG. 9 is a signal view showing all alarm events over a two month period.

FIG. 10 is a lags view showing cross-correlation between a pair of variables as a function of time.

FIG. 11 is a state space view labeled according to key performance indicators.

### DETAILED DESCRIPTION

The embodiment described here is used as a Process Data Management System (PDMS), which deals with data from industrial processes. It will be appreciated that the present invention may be used to analyze data from other sources.

Due to the amount of data produced by a typical industrial process, and the speed at which it must be handled, specialized data structures have been developed to represent this information. An industrial process is intended to mean a non-trivial process in which one or more raw materials are converted into a product. Typically some of the variables in the process may be controlled, such as for example temperature, pressure, flow rate, amount of a raw material. Some of the variables may not be able to be controlled, such as for example ambient temperature, or purity of a raw material. Some examples of industrial processes include an ore refining process, a production line process, a mining process and a construction process. These lists are exemplary and are not indented to be limiting.

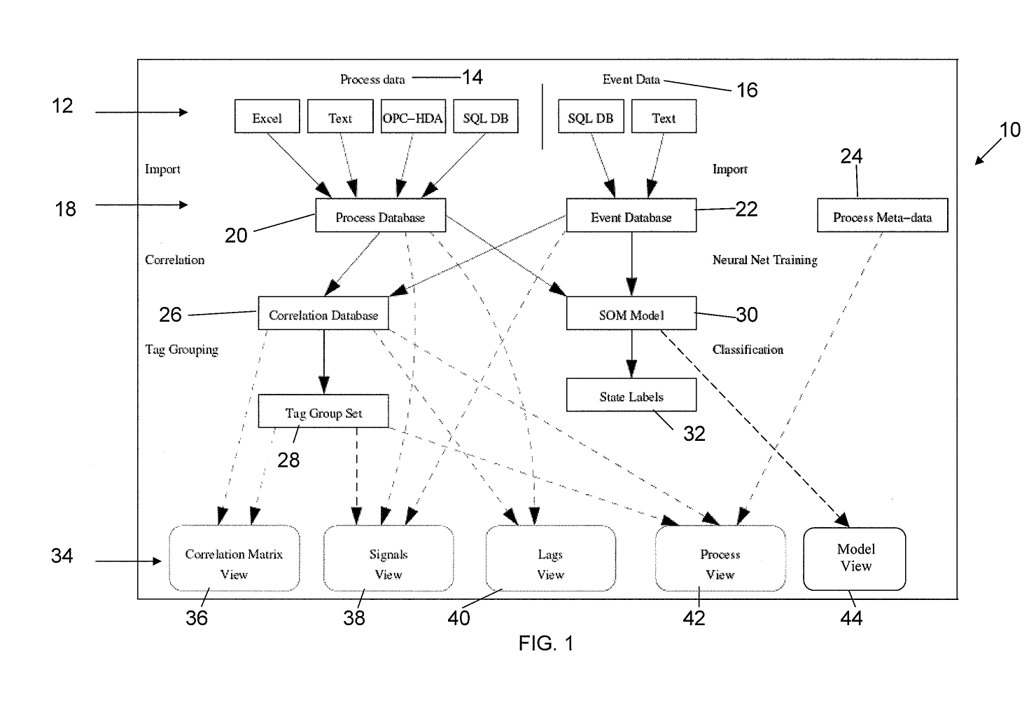

FIG. 1 shows a schematic overview of a process of producing visualizations from imported data according to an embodiment of the present invention. As will be described below the visualizations allow the data from the process to be analyzed to gain an understanding of the process or characteristics of the process. Data 12 is provided from a number of sources. The data 12 is divided into process data 14 and event data 16.

Process data 14 is regularly-sampled time-series data collected from sensors in the process. The characteristics being measured by the sensor is referred to as a variable and the value(s) of the variable at a given moment in time forms an element of data. Typically, the signals are sampled continuously, with averages being recorded every minute. For a process with 1000 variables, this equates to approximately 1.5 million data elements per day. Occasionally, there are problems with sensors, or with the collection of data from the process historian. This means that data may not be available continuously, and may have “holes”. Process data 14 is obtained from an Excel spreadsheet, a text file, an OPC-HDA or an SQL database. (OPC stands for “OLE for Process Control.”) OLE is a Microsoft protocol for communicating between application processes. OPC is a set of communication protocols used by the process industry, based on OLE communication mechanisms. OPC protocols include: OPC-DA (or OPC Data Access) for real-time access to the values of process variables and OPC-HDA (or OPC Historical Data Access.)

Event data 16 is irregular data generated to describe events or exceptional conditions. An example of event data is an alarm which is triggered when a certain condition or conditions is/are met. Event data 16 may be obtained from an SQL database or text file.

The process will usually have process meta-data. The meta-data is data about the process, rather than data collected by operation of the process. It may include descriptions of the structure of the process (for example plant drawings) and the meaning of process variables etc.

The process data 14 and event data 16 are collected into databases 18. The databases include a process database 20 and an event database 22 and a meta-data database 24. These databases 18 are used to produce dependent databases.

Correlation techniques are applied to the process data 14 in the process database 20 and event data in the event database 22 to find similarities between variables. The resulting correlation data is saved in a correlation database 26.

The correlation database 26 can then be used to tag variables that are similar to one another. Such similar variables are stored in a tag group set 28.

The process data 14 in the process database 20 and event data 16 in the event database 22 may also be used to train a neural network to generate a model of the process. In this example a self organizing map (SOM) model 30 is generated. The SOM model can be used to classify the state of the process and to produce state labels 32.

The resulting information can then be used to visualize various aspects of the process. Visualizations 34 can be produced from this information to determine different aspects about the process. The visualizations 34 are useful to show a user, such as a process engineer, what the process is actually doing, as opposed to what the process ought to be doing. The visualizations 34 aim to improve the insight of the engineer into the workings of the process. Relationships revealed by the visualizations can reveal unexpected relationships, confirm that relationships that were thought to exist do in fact exist and also can reveal relationships that should have been obvious as a logical consequence of the process design, but the engineer may not have made the required deductive link.

The examples of the visualizations 36 include: a correlation matrix view 36, which uses information from the correlation database 26 and the tag group set 28; a signals view 38, which uses information from the tag group set, the process database and the event database; a lags view 40, which uses information from the correlation database and the process database; a process view 42, which uses information from the tag group set 28, the correlation database 26 and the process meta-data 24; and a Model View 44, which may also be visualized as will be described further below. Other visualizations are possible.

### Data

The process data 14 is imported and stored in the process database 20. The process database 20 holds the process data 14 as a set of values over time for each of the variables in the process. It is important that process data 14 be represented in a way that is both compact and efficient to access. For rapid visualization, it is important to be able to quickly retrieve samples based on a given time range. While general purpose databases are useful in many applications, they impose an additional layer of software and processing between the application and its data. In the PDMS, this may not be acceptable because of the required speed at which information must be processed. Therefore, specialized representations may be used that use domain information to improve speed and reduce the size of the stored data.

Each process variable may define a series of components to its value over time. For example, each sample may have the following components:
Time (32-bit integer).
Duration (32-bit integer). Together with start time, this indicates the time interval over which the sample is valid.
Value (32-bit float).
Range (2×32-bit floats). For samples that have been derived from a number of other samples, the system optionally stores a maximum and minimum in addition to the value. This allows (for example) a visualization of a decimated time series to display the full range of the signal for each sample.
Extra Attributes (8- or 32-bit integer). Each sample may be tagged with one or more additional Boolean or integer attributes packed into integer bit-fields. The main system-defined attribute is Quality, which is defined for data imported from OPC-HDA data sources. Other tags may be defined by the user, and applied on a per-sample basis to stored data.

There is usually a certain amount of redundancy in the process data 14 that means that not all of the components need to be stored. The PDMS can use information about this redundancy to reduce the size of the stored data, and improve retrieval time.
Time: Most data is periodic, so a stream can be represented as a sequence of periodic regions. Each region is defined by a start time, sampling period (duration), and a number of evenly spaced, contiguous samples. Time and duration are not explicitly stored for each sample, but are calculated from the region header. Providing the number of holes (i.e. breaks in the periodicity) is small, this representation roughly halves the storage per sample.
Range: Most data that has been imported from a Distributed Control System (“DCS”) is averaged, but does not define the range of the original values. For this data, the range is not stored but is defined to be equivalent to the value.
Attributes: If a quality measure is not available and no user-defined attributes are defined then there are no additional attributes to be stored, and this field is omitted in the data. If quality is defined, the user may choose to filter out “bad” values in pre-processing, in which case all samples in the time-series are implicitly “good” and again, the attribute field is omitted.
Quantization: with the above considerations, most time-series data can be represented using a 4-byte float data type per sample. If less that 32-bits precision is required, it is possible to quantize the data using a per-stream scale and offset factor to map between 32-bit floats and 8- or 16-bit integers. Repeats: when consecutive periodic samples have the same values for attributes that are defined (i.e. value, range, and extra) a run-length encoding is used. Values are stored just once along with a repeat count.

For periodic data, samples can be rapidly located using a computable offset from the start of each region. For aperiodic data, a binary search allows a given sample to be located in O(log(N)) time, for N samples.

When process data 14 is imported into the process database 20, certain statistics of the data 14 are calculated and stored in the process database 20 with the data stream. These include: mean, standard deviation, various central moments (skewness, kurtosis), maximum, minimum, and frequency distribution (represented as a histogram using a pre-set number of frequency bins). This information is used during visualization to provide an appropriate scaling for display. The frequency distribution is also used for display, and for certain types of normalization.

Compression of the process database 20 is not preferred. Many well-known techniques of compression exist including boxcar, backward slope, and straight line interpolation methods. These techniques are lossy (i.e. they discard information) so the reconstructed data may be inaccurate in ways that could be statistically significant. However it is anticipated that some versions of the PDMS may incorporate data compression as an option.

A facility to decimate time-series data (i.e. to reduce the sampling rate) after filtering out high frequency components may be included. In doing so, it preserves the range information in the resulting data stream because this is an important indicator of variability. This makes it possible to pre-compute a representation of each signal at a number of pre-defined time scales (e.g. 1 minute, 10 minutes, 1 hour, 1 day). This technique (similar to “MIP maps” in 3D graphics) can be used to further accelerate the display of data over long time-scales.

The PDMS includes utilities for importing process data from a number of sources:
Spreadsheet files.
Text files.
Databases.
OPC-HDA servers.

Spreadsheet files are typically encoded using Microsoft Excel data formats. Many tools shipped with DCS or process historians allow data to be exported in this format. However, there are many limitations on what data can be represented in spreadsheets. Typically, worksheets can have at most 255 columns and 65535 rows. To overcome these limitations, the import system allows process data to be distributed across multiple directories, spreadsheets, and worksheets. An import “wizard” may be used to allow the user to specify what data to import, and how the different sample attributes and meta-data attributes are encoded.

OPC-HDA is a Distributed Component Object Model (“DCOM”) based protocol for importing historical data from process historians. DCOM is a Microsoft protocol for communicating between application programs that may be running on different machines. Typically, a process historian (e.g. Pi) collects data in real-time from a DCS system and stores it in a specialized database, usually with the aid of various compression techniques. The OPC-HDA protocols allow clients to retrieve the stored data. This includes:
Time
Value
Quality

Process data 14 may be imported directly from OPC-HDA servers.

One problem with certain import methods is that process meta-data is not available. For example, OPC-HDA servers often do not support tag browsing. Therefore, a mechanism to separately import meta-data from text files (in CSV format) may be implemented.

Events 16 are conditions with well defined time and duration. Events are usually related to alarm conditions. Change in alarm state is described by several types of types of events. Alarm events indicate the time at which an alarm started. Return events indicate when the alarm stopped. Other events indicate how the operators respond to the alarms. For example, Enable, Disable, and Acknowledge. Other kinds of operator actions may also be recorded. For example, changes to operating set points, and operating modes.

Typically, event streams are used for visualization or alarm analysis. However, for visualization it is important that the event data be efficiently accessible so the visualization tools generally require that a fast binary representation to be used.

The Event Database 22 is a stream of events 16 defined for a number of event variables. In this context, an event variable corresponds to a state of a DCS tag. Events are defined by the following attributes:
Time.
Tag.
Event Type (alarm, return, acknowledge, operator action).
Subtype (HI, HIHI, etc).
Priority (high, low, emergency, diagnostic, etc).

Events are stored in a compact binary representation. Times are strictly ordered, so that the closest event to a given time can be located in O(log(N)) time, where N is the number of events. Most attributes are of enumerated types (tag, event type, subtype, and priority) and are represented using small integers (8- or 16-bits). Small look-up tables are used to map these integers to/from string tags. This also ensures that event records have a fixed size, which makes indexing simpler. Each event record also contains a pointer to the next and previous event of the same type, so it is quite efficient to enumerate all of the events of a given type, or to find (for example) the next return event corresponding to a given alarm event.

Event streams may originate from a number of sources:
Event logs (e.g. text printed by a DCS)
Event databases, stored in database tables or spreadsheets.

Normally, events are generated by the DCS, and are logged in an external system. This may be an external process historian, or a customized system like an IMAC logger.

The PDMS imports event streams from text streams, or from databases. For data-base import, the user specifies which columns of the input correspond to the event attributes listed above. The user can also define specific mappings between the values of these fields and the resulting enumeration value (e.g. there may be more than one string used to represent an event type, or sub-type). This allows the conversion and the event model to be customized for a particular site.

Process meta-data 24 is information about the process, as distinct from information collected from the process. This includes:
Descriptions of the variables and events in a process. This information is used in the analysis and visualization of data. It includes the DCS name, description, measurement units, and any other information about the measurement (e.g. sensor type, precision, etc).
Descriptions of the relationships between the variables. For example, a measurement point may be associated with more than one process variable. A variable that is controlled automatically may have in addition to its value, a set-point and a controller output.
Descriptions of the structure of the process. Normally, a process is logically divided into separate units. This defines specific physical and functional relationships between variables.
Drawings of the process structure. This includes process and instrumentation drawings (P&ID).

Meta-data is used for visualization, and during analysis to select variables based on criteria that are meaningful in the domain.

Several types of meta-data may be represented within PDMS. Each stream of process data is associated with the following attributes:
Tag Name
Description
Units
Precomputed statistics and frequency distribution.

This information is stored in the process meta-data database 24.

Certain types of visualization in the PDMS make use of process drawings. The drawings are stored as image files (e.g. using GIF format). These files can be produced by exporting the data from a CAD system, or by scanning printed drawings. They can be annotated by the user to indicate the position of important process variables. The annotation is stored using an XML data format. The process database may include a drawing database comprising multiple drawings, each with an associated image and XML annotation.

Most existing tools require that data be memory resident. That is, they assume they can hold all the relevant data in memory. This limits the quantity of data that can be analyzed. The PDMS uses data structures that are usually stored on disk, and hence do not rely upon the availability of adequate computer memory. The PDMS can deal with large data vectors collected over long time intervals. This leads to datasets that are very large, and can exceed the available memory in any typical high end computer. Indexing methods are included that allow fast retrieval of data from disk and fast manipulation in memory. Recursive decomposition of data to optimize data for the time-scale of interest avoids using sub-second data for a year's analysis but also avoids data loss that is common in process data compression algorithms used in most historical visualization tools.

The PDMS deals with data from both batch and continuous processes. There are very few tools available for batch processes. This is because of the complexity of the description of batch processes. Batch processes require two time dimensions to handle both elapsed time and time in a process state. They also require a description of the actual process equipment associated with any particular batch because multiple processing paths may exist through a typical batch process. They also require a representation of the state of the process and the current process step being employed to be recorded in the data sets.

### Correlation

The correlation database 26 comprises correlation data. Correlation data measures the similarity between process variables. The PDMS computes the lagged correlations for all pairs of variables, up to a defined time lag.

Given a data series xᵢ, the mean x is:

$$\overline{x} = \frac{{\sum }_{i = 1}^{n} {x}_{i}}{n}$$

For two data series xᵢ and yᵢ, the covariance s_{xy} is:

$${s}_{xy} = \frac{{\sum }_{i = 1}^{n} ( {x}_{i} - \overline{x} ) ( {y}_{i} - \overline{y} )}{n}$$

The simple variance sₓ of xᵢ is:

sₓ²=sₓₓ

The correlation R_{xy} of two xᵢ and yᵢ is the covariance normalized by the product of the variances of the two series:

$${R}_{{x}_{y}} = \frac{{s}_{xy}}{{s}_{x} {s}_{y}}$$

The lagged correlation R_{xy}(t) is the correlation of xᵢ and yᵢ₊ₜ. That is, the correlation of x with the series y lagged by t.

If there are N variables, and L time lags, the resulting data structure is a three-dimensional matrix of size N·N·L. This data structure can be quite large, and is typically larger than the available memory on the host computer. Therefore, it is stored in a database format that can be quickly retrieved and visualized.

For example, if N=1024 and L=512 the resulting size would be 2¹⁰⁺¹⁰⁺⁹⁺², or 2³¹ bytes (2 Gigabytes, with data stored as 4-byte floats).

The correlation database is typically accessed in two ways:

Given a pair of variables, what is the associated lagged correlation? This information is used for categorizing the relationship between a pair of variables (e.g. are they correlated, and if so at what time lag). The lagged correlations and autocorrelations may be plotted for visual inspection.

Given a time lag, what is the associated correlations between variables? This information is used determine groupings of variables or for visualizing clusters of related variables.

Both functions need to be rapidly retrieved, since it is not feasible to quickly recalculate the required values. Therefore, the correlation matrix is stored in two forms:
N by N matrix of length L lag matrices.
L matrix of N by N correlation matrices.

The correlation matrix is derived by considering pairs of process variables. For N variables, there are N*N pairs of variables. The lagged correlations are computed using a technique similar to Rader's method for high-speed autocorrelation [C. M. Rader. An improved algorithm for high speed autocorrelation with applications to spectral estimation. IEEE Transactions on Audio and Electroacoustics, 18:439-441, 1970]. This efficiently computes the cross-correlation in the frequency domain.

Correlation in the time domain is equivalent to multiplication in the frequency domain. The data is transformed in sections into the frequency domain using the Fast Fourier Transform (“FFT”). Straightforward multiplication produces a cyclic correlation. Linear correlation can be obtained by padding one of the sequences with the same number of zeros.

The FFT is a class of efficient algorithms for computing the Discrete Fourier Transform (DFT). FFT algorithms rely on N being composite (i.e. non-prime) to eliminate trivial products. Where N=r₁.r₂ . . . rₙ the complexity of the FFT is O(N(r₁+r₂+ . . . +rₙ)). When an algorithm has complexity O(n), kn is an upper bound on its run-time, for some constant k. The basic radix-2 algorithm published by Cooley and Tukey (J. W. Cooley, J. W. Tukey “An algorithm for the machine calculation of complex Fourier series Math. of Computation 19 (1965) 297-301”) relies on N being a power of 2 and is O(N log₂ N). Other algorithms exist which give better performance. Higher radix algorithms achieve slightly better factorization and cut down on loop overheads. In addition to saving run-time, the FFT is more accurate than straightforward calculation of the DFT since the number of arithmetic operations is less, reducing the rounding error.

An efficient algorithm for computing autocorrelation is given by Rader. Suppose that x(n) and y(n) are input sequences of length N. The inverse transform of X(k)Y*(k) gives the cyclic correlation. To get a linear correlation, an equal number of zeros must be appended to one input sequence. However, in practice N is very large compared with the number of lags desired. In this case, the data can be processed in smaller sections. Let xⱼ(n) denote a length M sequence formed by taking M/2 points from x and appending M/2 zeros as follows:

$${x}_{j} ( n ) = \{ \begin{matrix}x ( n + jM / 2 ) & 0 \leq n < M / 2 \\ 0 & M / 2 \leq n < M\end{matrix}$$

Let yⱼ(n)=y(n+jM/2) 0≦n<M
In the frequency domain form the product

Wⱼ=Xⱼ*(k)·Yⱼ(k)

The first M/2 elements of wⱼ represent the contribution of the j th section of x and y to the cross-correlation. Let

$${Z}_{j} ( k ) = {\sum }_{m = 0}^{j} {W}_{m} ( k ) = {Z}_{j - 1} ( k ) + {W}_{j} ( k )$$

Then the cross-correlation is given by

R(k)=(1/N)IDFT{Z_{(2N/M)-1}(k)}

For autocorrelation, Rader employs the simplification:

Yⱼ(k)=Xⱼ(k)+(−1)^{k}Xⱼ₊₁(k)

For cross-correlation, we use the fact that Yⱼ can be similarly derived from two shorter sections:

Yⱼ(k)=YYⱼ(k)+(−1)^{k}YYⱼ₊₁(k)

where yyⱼ is defined analogously to xⱼ:

$${yy}_{j} ( n ) = \{ \begin{matrix}yy ( n + jM / 2 & 0 \leq n < M / 2 \\ 0 & M / 2 \leq n < M\end{matrix}$$

Thus, it is never necessary to form the sequence yⱼ(n) or take its transform Yⱼ(k). Multiplying a DFT by (−1)^{k} corresponds to a shift in time of M/2 positions. The efficient algorithm can be summarized:

(1) Form x₀(n) and yy₀ and calculate the transforms X₀(k) and YY₀

Let Z₀(k)=0, for 0≦k<M

For 0≦j<2N/M−2 do

a) Form xⱼ₊₁(n) and compute Xⱼ₊₁(k)

b) Form yyⱼ₊₁(n) and compute YYⱼ₊₁(k)

c) compute Zⱼ₊₁(k)=Zⱼ(k)+Xⱼ*(k)[YYⱼ(k)+(−1)^{k}YYⱼ₊₁(k)]

### Let

$$R ( s ) = \frac{1}{N} IDFT ( {Z}_{2 N / M - 1} ( k ) )$$

keeping only the first M/2+1 values.

Thus, the cross-correlation is computed using 2N/M sections. Each section involves two DFT operations of length M to compute X(k) and YY(k). Thus the cross-correlation is computed with 4N/M length-M DFT operations. However, the number of lag values is not rigidly tied to the transform length M. Lag values pM/2≦s≦(p+1)M/2 can be obtained by accumulating:

Zⱼ₊₁^{p}(k)=Zⱼ^{p}(k)+Xⱼ*(k)[YYⱼ₊ₚ(k)+(−1)^{k}YYⱼ₊ₚ₊₁(k)]

This fact justifies the decomposition of yⱼ(n) terms of sub-sequences yyⱼ(n)+yyⱼ₊₁(n). Explicitly calculating Yⱼ(n) is no more expensive than computing YYⱼ(n). But in order to handle further lag sections as described, it would have to be calculated for every additional lag section. The decomposition approach allows the calculation to be done once for all p lag sections. By keeping the transforms of the previous p values of YY, all values of Y can be derived at the cost of a single DFT.

### Process Model

A process model 30 is a simplified representation of the process. The model is derived from process data 14, and seeks to approximate the joint distributions of variables in the process. In doing this, it represents the state space of the process, but using a much smaller number of points than the original training data.

The PDMS uses a neural network to model the state space of a process. Specifically, a Kohonen Network, or Self-Organizing Map (SOM) is used. The discussion in this section relates to SOMs, but other types of models can be used.

The process model 30 can be used to answer questions such as:
Is the process in an abnormal state? Given a SOM process model and a current operating state, we can locate the closest neuron to the current state and measure the distance between the neuron and the state. This measure (termed the “quantization error”) will be low for previously encountered (i.e. learned) states, and high for states that have not been seen before.
Is the process in a particular (e.g. good, bad) state? Given that the process state can be labeled, we can build a SOM model that distinguishes between different classes of states. The SOM learns the criteria that define each class, and can be used to classify a given operating state.

In addition to modeling and classification, the SOM can be used to visualize the state-space. The SOM produces a two-dimensional representation in which points that are close in state-space are close in the two-dimensional map. It is therefore an adaptive, non-linear projection of the state space. Which preserves (where possible) neighborhood relationships. Linear projections (like PCA) cannot do this. Current, or historical process states can be projected onto the SOM visualization. The user can then locate similar states based on the learned classification criteria.

The PDMS currently uses an open-source SOM toolbox for Matlab, 2003. http://www.cis.hut.fi/projects/somtoolbox/.

SOM models are derived from process data extracted from the PDMS process database. During a training phase, a SOM map is built using the documented procedures in the toolbox. Often, some preprocessing is required:
Remove outliers.
Generate data using the intersection of available signal regions. This avoids the user of “missing” values which can cause the training routines to use unwanted interpolation schemes.
In some situations, a better solution results if the SOM is first trained on principal component data, and then trained on the raw data.

### Tag Group

A tag group is a group of variables that are related in some meaningful sense. Tag groups can be defined explicitly using process knowledge, or can be calculated from time-series data.

Tag grouping is calculated dynamically by the visualization system and is used to interactively select variables and examine their relationships. Each variable in the process is associated with a group label based on an analysis of the cross-correlation matrix. This information can be output, but is not routinely stored. Example grouping follows:

### —Label 0—

### 03AA617B.PV:CR3 NAPTHA SPLIT BTMS ANALYZER

### 03AA617B.EV:COMMON FAULT

### —Label 1—

### 03AC606.PV:B332 FLUE GAS O2

### 03AC607.PV:B331 FLUE GAS O2

### 03AC608.PV:B333 FLUE GAS O2

### 03FX233.PV:B332 RATIO COMB AIR/FUEL

### 03FY233C.PV:B332 AIR/FUEL CALC

### —Label 69—

### 03UA020E.EV:LOCK HOPPER CTRL CYCLE

### 03UI021L.EV:LHOP CTRL VLV RAMP

### —Label 70—

### 03UA072.EV:MOIST ANAL CMN FAULT

### 03UA079.EV:DENSITY ANAL CMN FAULT

717 variables
71 labels
391 variables in labels (54.532776%)

### Threshold=0.9

User-defined grouping of tags may be supported. This would enable sets of variables to be identified by the process engineer and associated with meaningful attributes. These sets could be defined by hand, or could be based on the groupings derived from analysis of the process data.

A simple process for computing grouping is as follows. Two variables x and y are said to be related rel(x,y) if their correlation falls between a defined range t_{L}≦R_{xy}(t)≦t_{H}.

Tag groups are defined by forming the transitive closure over the relation rel. That is, x and y are in the same group if x is related to y, or x is related to z and z is related to y.

As stated, tag grouping depends on a number of parameters:
A high threshold t_{H}.
A low threshold t_{L}.
Any parameters that identify the current cross-correlation matrix (i.e. a particular time lag, or maximum over all lags).

### Data Manipulation

The PDMS includes an environment for manipulating events, process data and process meta-data. The Data Manipulation Environment (DME) is an environment for constructing and evaluating functions which operate on process data. The DME implements the “Interpreter” design pattern. Operations may be specified using a textual description, similar to a programming or scripting language, or a visual programming system may allow operations to be specified within a graphical environment. Applications of the DME include:
Data pre-processing. This allows imported data to be manipulated in various ways prior to analysis. Some useful manipulations include:
   Filtering: removing data points based on various criteria. For example, filtering can be used for removing outliers, or known shutdown periods from the data. It can also be used to generate reduced data sets (e.g. with fewer variables, or restricted time ranges) for investigating particular incidents or problems. For batch processes, filtering is used to extract values for significant process states (i.e. to select values of one variable based on the value of another state variable).
   Transformation: modifying the values of data points using various rules. For example, simple linear transformations can be used to remove scale effects. Normalizing a value based on its probability (given its measured distribution) can reduce the influence of outlying values on the visualization and statistical correlation of variables.
   Calculated variables: creating new variables from existing variables. For example, given a measured density and flow velocity, the user may wish to calculate the mass flow rate. This is new variable is defined in terms of two existing variables. Given a measurement and a threshold, the user may wish to define an “alarm” or “state” variable that indicates when the measurement is above the threshold. Once defined, these variables can be treated the same as imported variables (i.e. for the purposes of visualization and analysis).
   Decimation: reducing the volume and rate of data using low-pass filtering.
Analysis. Operations on data (such as cross-correlation) require the specification of options and parameters. This can be done systematically within the DME framework.
Scripting. Repetitive or routine operations can be formalized and defined as functions.

The DME includes specialized databases for storing process and event data. It allows access to stored data via abstract streams. A stream of T is a sequence of values of type T. Functions are provided for accessing stored streams, for filtering (e.g. removing outliers) and transforming (e.g. normalizing) streams, and for calculating features of streams. An important feature of DME streams is that they are handled using lazy evaluation. This means that very large data structures can be handled without requiring that they be resident in memory. Sequences of operations can be defined using ordinary function composition. Intermediate results are only ever partially computed (on demand) so the memory requirements are very small compared to systems like Matlab which generally keep all results in memory.

An additional advantage of a stream-based representation is that it can operate equally well on real-time data. In a real-time environment, data is being continuously produced but is only ever partially available. Again, stream operations can be defined using function composition. As new input becomes available, new results are computed.

The DME is a simple language that merges aspects of imperative, functional and object-oriented programming. Important features are:
First-class functions. Functions are values that can be passed to other functions, received as arguments or returned as results.
First-class typed streams. Streams are sequences of values that may be passed to functions as arguments or returned as results. Streams are evaluated incrementally as required.
User-defined data structures (e.g. records).
Parametric collection types (e.g. sets, arrays).
Strong type-checking.
Java interface. The DME is preferably, but not essentially, implemented in Java. Using Java's reflection interface the DME can create Java objects, and call their methods. This facility is used to implement core DME types and functions, but can also be used to implement system extensions.

A version of the PDMS could allow DME operations to be constructed graphically, within a visual programming environment. For example, functions can be considered as blocks with defined inputs and outputs. These can be treated as nodes in a graph, with edges being added interactively by the user to indicate data-flow. This will allow DME operations to be constructed in a constrained way that does not require deep understanding of a language structure.

### Visualizations

The PDMS provides a system for identifying relationships in a process by analyzing data from that process. The value to an engineer is that it reveals not what the process ought to do (as might be defined by a model or simulation), but what it actually does (as revealed by the data). The aim is always to improve the insight of the engineer into the workings of the process.

Some of the relationships revealed may be unexpected (e.g. the result of faults or redundancies in the process). Other relationships will be “obvious” relationships of which the expert will already be aware. Other relationships “should have been obvious”. That is, they are the logical consequence of the process design, but the expert may not have made the required deductive link. All of these relationships play an important role in understanding the process.

One of the keys to deploying this advanced technology in industrial processes is a simple, easy to follow user interface. In the following examples some of the typical operations that an industrial user would use are shown.

### Cross-Correlation Matrix

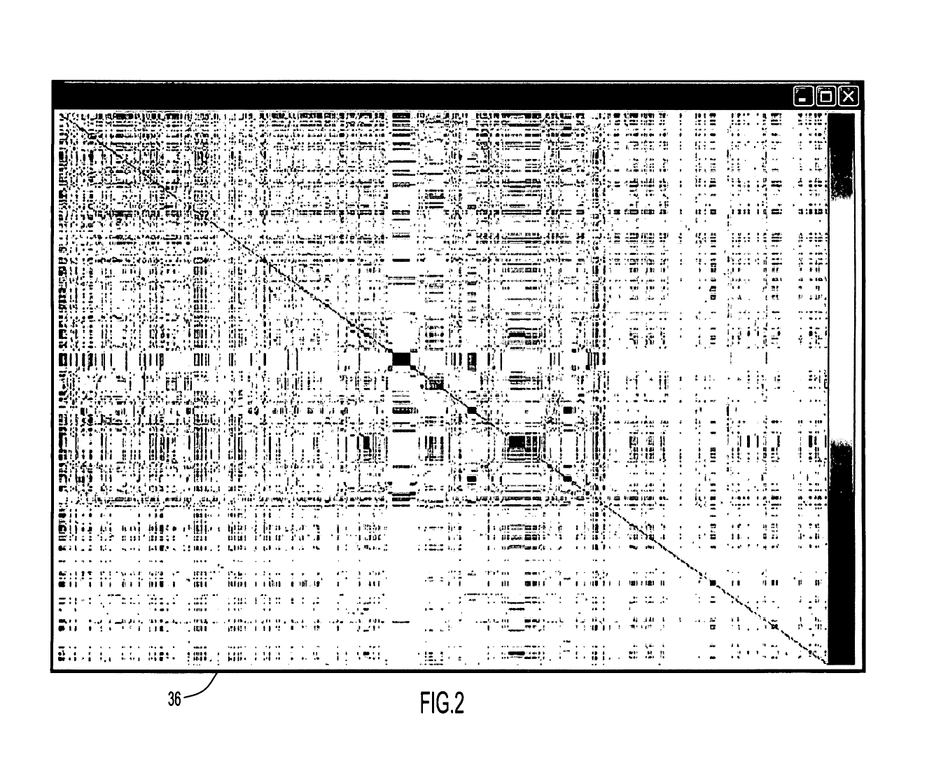

The matrix view 36 displays the cross-correlations between a set of variables at a given time lag, or the maximal value over all time lags. Each row represents a different variable and likewise each column represents a different variable. The rows and columns usually have the same set of variables. Thus there is one row and one column in the matrix for each variable. The cell at the intersection of row A and column B indicates the correlation between variables A and B. The diagonal line from top right to bottom left is produced due to the same variable being at both the corresponding row and column. The correlation is represented in FIG. 2 using different types of shading, but this is better represented using a color map.

FIG. 2 shows a sample correlation matrix view. The figure shows relationships between 717 variables around a catalytic reformer. Each row and column in the picture corresponds to a variable, and the color at their intersection indicates the degree of similarity between the variables. The scale at the right shows the encoding of similarity via color. Red (or the shading at the top of the shading scale on the right hand side) indicates a high positive similarity, blue-green (shading in the middle) indicates low similarity, and violet (shading at the bottom) indicates high negative similarity. The picture shows the 514089 possible relations between these variables at a particular time lag (here, zero or instantaneous similarity).

The variables in the top left are continuous process variables. The variables in the lower right are alarm variables. The amount of red and violet in the picture indicates the degree of redundancy or similarity between the variables. Within the correlation matrix view several operations are available to the user:
Zoom in and out of the image to select a smaller or larger region of the correlation matrix to display.
Select a cell with the mouse. The system automatically selects variables in the related group, if one exists.
Reorder the correlation matrix by moving rows or columns to different positions in the matrix.
Interactively change the mapping between correlation value and color.
Change the time lag for correlation, possibly causing the tag groupings to change.

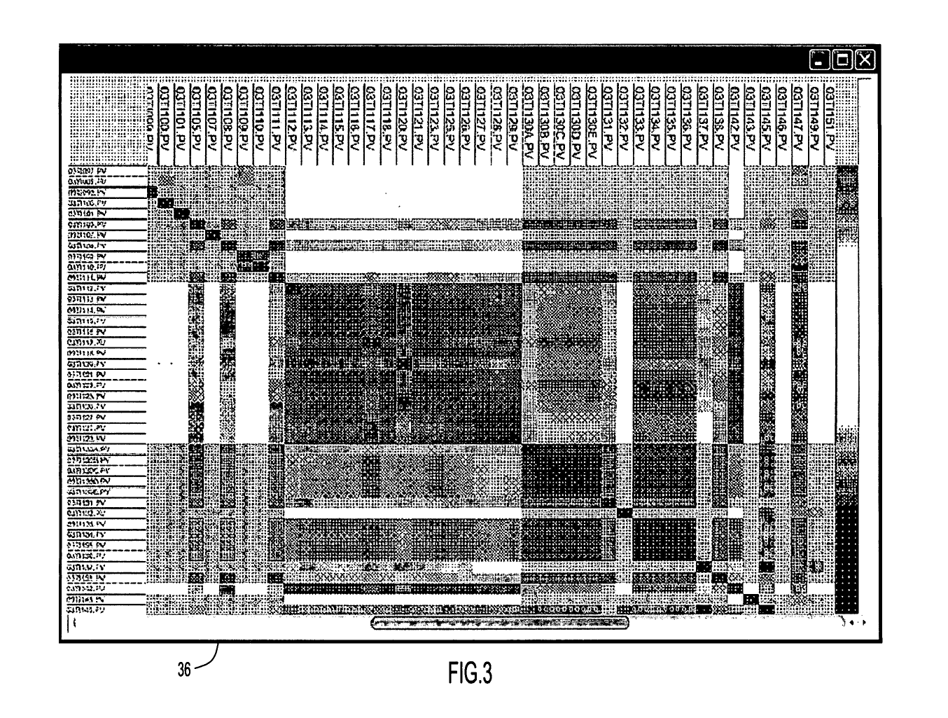

FIG. 3 shows a region of the matrix in FIG. 2 in greater detail. At this level the names of process variables are visible. The highlighted (bright) cells correspond to members of a group of variables that has been calculated by the system and selected interactively by the user.

### Process View

The process view 42 allows the user to visualize the layout of the process, while overlaying information about the tag grouping, and correlation between process variables. The various stored types of meta-data include annotated process drawings. The process view displays these drawings, and uses the regions defined by the annotations to project the tag grouping or cross-correlation data.

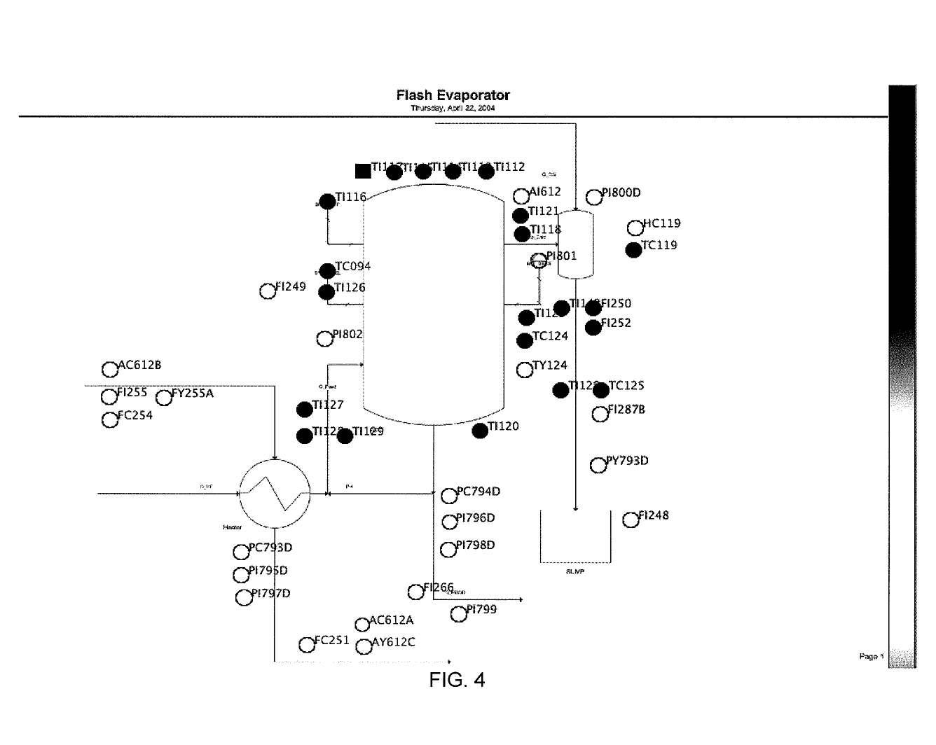

FIG. 4 shows an annotated process diagram. The tag group in the previous example has been projected on the process and instrumentation drawing (P&ID). Variables are indicated by labeled circles on the plot. Red circles correspond to variables that exist in the cross-correlation data. Black circles correspond to variables that are defined in the annotation, but not in the data.

A filled circle indicates a member of the defined tag group. An open circle indicates that the variable is not a member of the group. The variables in this diagram are active: selecting a variable with the mouse causes the system to highlight other variables in the same group. The selected variable is indicated by a red square. This example illustrates one of the applications of meta-data to the visualization of a process operation.

Operations available to the user include:
Zoom in and out to select a smaller or larger region of the process drawing to display.
Select a tag group by clicking on variables with the mouse.
Move to the previous or next process drawing in the set of available drawings.
Move to the previous or next process drawing containing a member of the currently selected group.
Change the display mode to show tag group, or similarity (see below).
Change the time lag for correlation, possibly causing the tag groupings to change.

The presence of similarity between variables normally indicates a causal relationship between variables. However, absence of similarity can also be important. Where an expected similarity is absent, it can indicate a problem in the process (e.g. incorrect controller tuning). The process view allows the engineer to visually examine these issues.

### Signals View

The signals view 38 allows the user to display data from the process or event database. This includes time-series data and event data. Time is shown on the horizontal axis. The variables are stacked vertically, with their scaled amplitude being shown on the vertical axis. Events are displayed as blocks, indicating the time region in which the event is in “on” (or in alarm). The user can select the signals interactively using a browser, or the selection can be synchronized with the variables in the currently selected tag group.

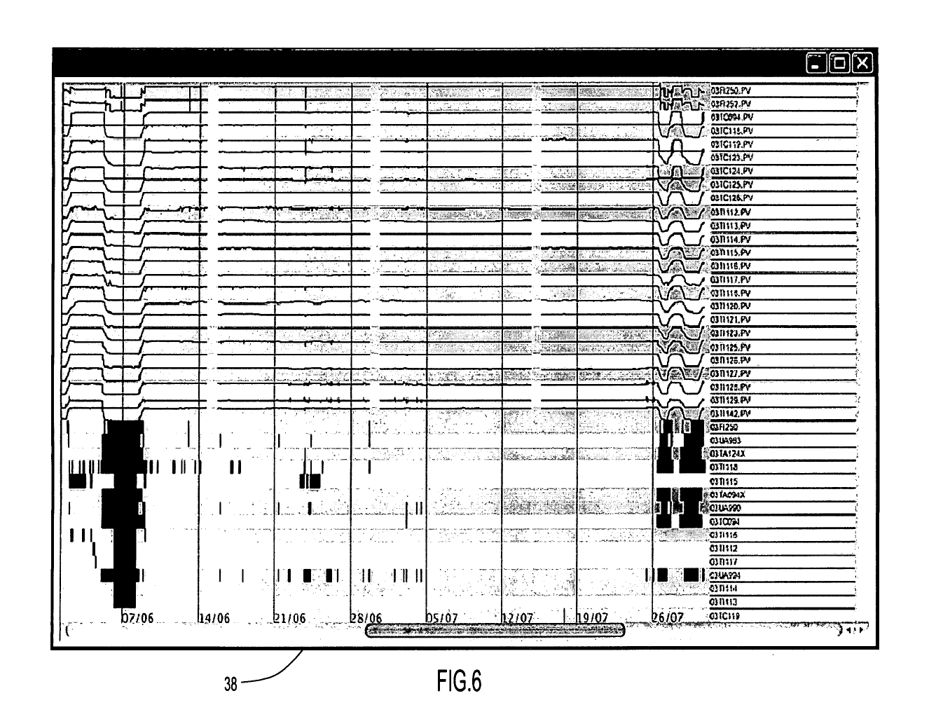

FIG. 6 shows the values of process and alarm variables that are members of a group of variables. Visually, the user can confirm the basis for the grouping of variables, and use features of the visualization system to investigate events in the data. This figure shows about 2 million process data points.

Operations available to the user include:
Rearrange signals by drag-and-dropping the signal labels (at the right hand side of the display).
Add, remove and reorder signals using a tag-set browser.
Zoom in or out of the plot to show a subset of the variables, or to change the scaling on the time axis.
Choose to display signal amplitude on the vertical axis, or using shading.

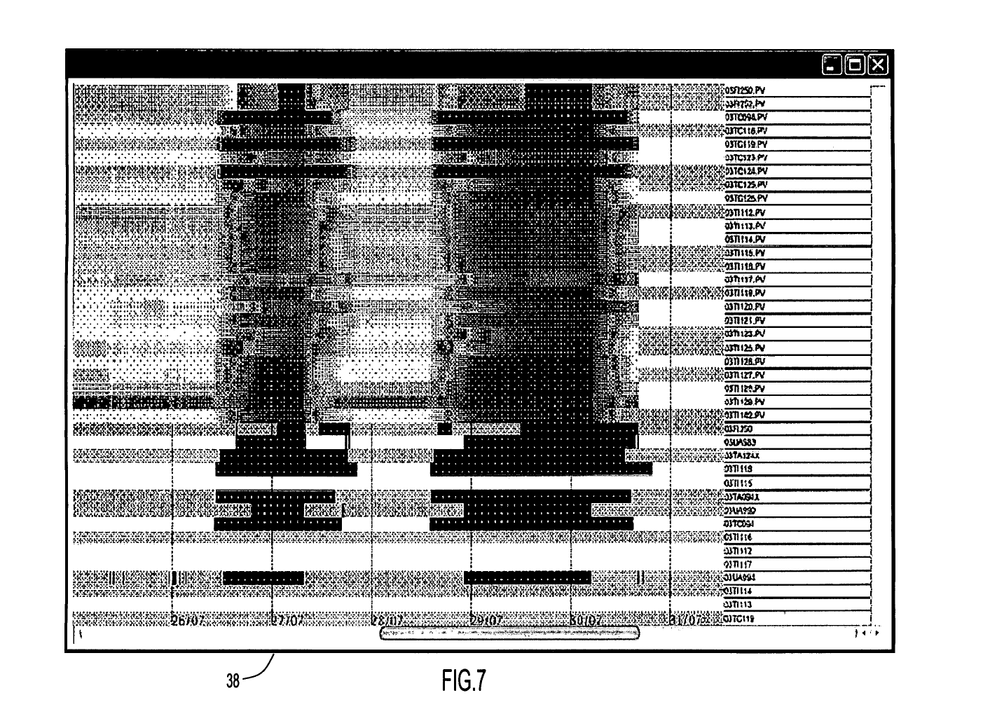

FIG. 7 shows the same variables as in FIG. 6, but here the signal amplitude is indicated using a color mapping (similar to the display of correlation intensity). This is useful when a browsing a large number of variables. In a regular plot there is insufficient vertical resolution to accurately gauge signal relationships, but this display allows correlation to be easily identified by looking for vertical banding in the image.

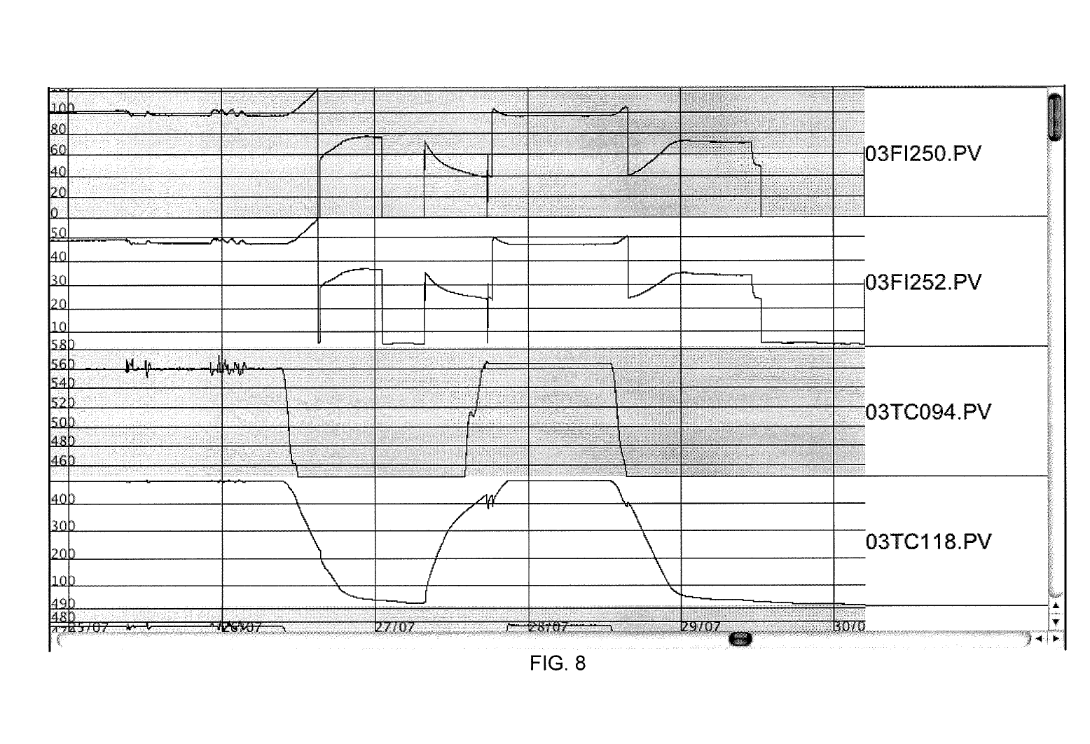

FIG. 8 shows a small number of variables. At this resolution, scale information is displayed, which allows the user to interpret the absolute values of the signals.

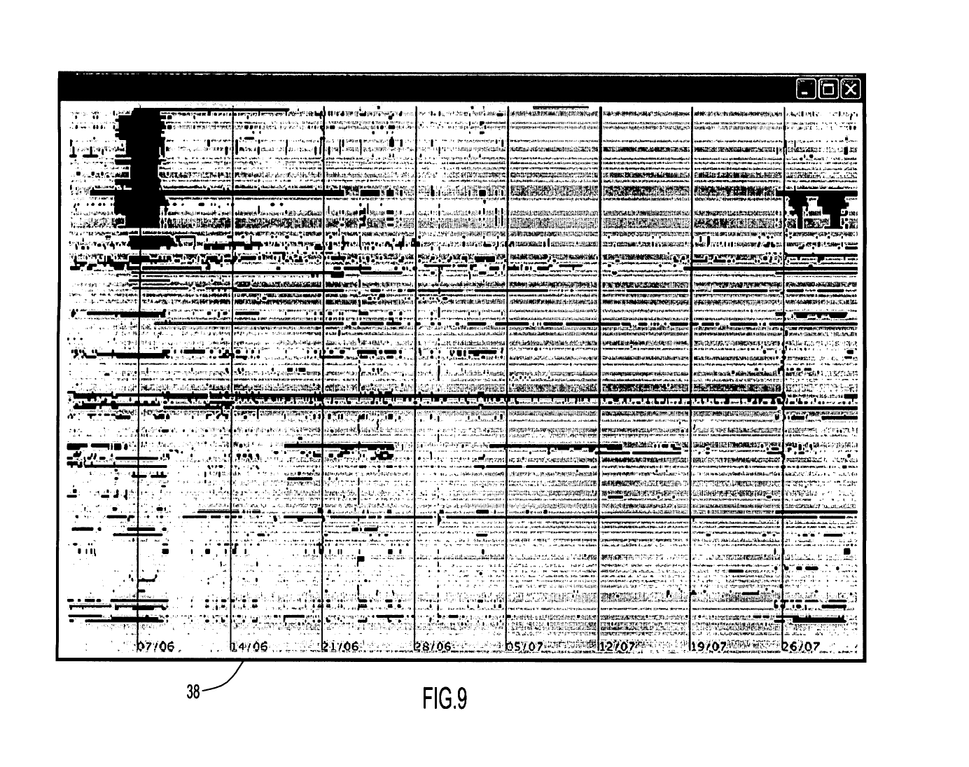

FIG. 9 shows the signal display being used to display only alarm events. This view shows every event that happened over a two month period (approximately 70 thousand events). Tags are ordered using tag grouping information. That is, tags that are in the same group are placed adjacent on the display. This makes it easy to visually identify the temporal patterns associated with each group, and also to compare the responses between different groups.

### Lags View

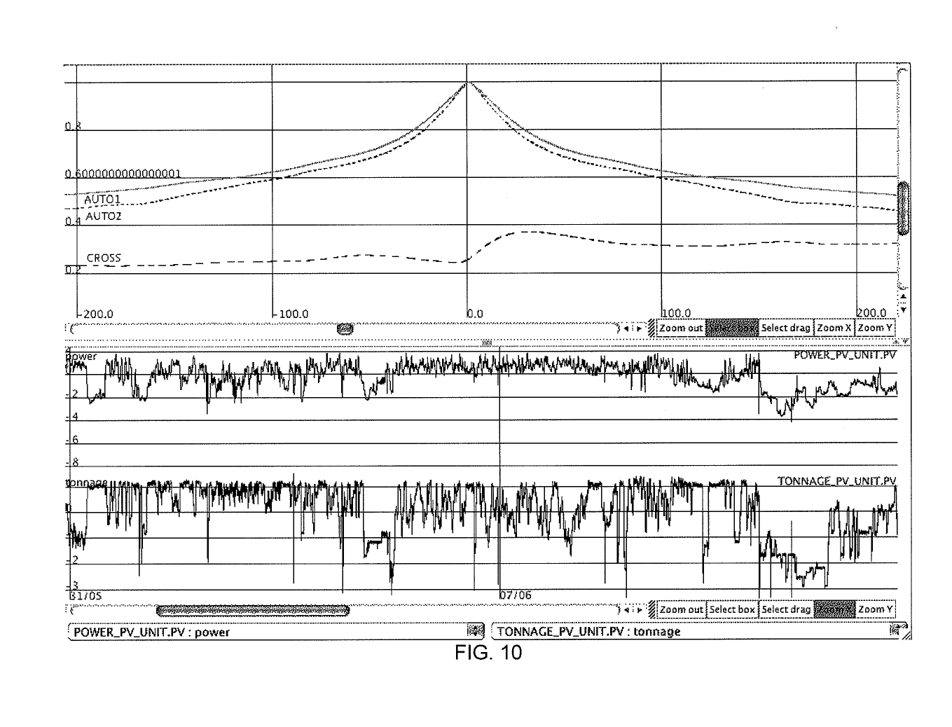

The previous examples showed ways of displaying instantaneous similarity, but in fact most processes involve propagation and lags, so the expected similarity is not always instantaneous. The Lags View 40 in FIG. 10 shows the lagged similarity between a pair of variables. The bottom half of the picture shows the time-series data for two variables. The top half of the picture shows the autocorrelations (labeled “AUTO1” and “AUTO2” in green and blue, respectively) and the cross correlation (labeled “CROSS” in red) for lagged time. In this example, the peak similarity between POWER and TONNAGE is at about 30 minutes.

The correlation database is represented in two ways. Previously, we displayed the N by N correlation matrix for a given lag L. Here, we display the length L lag matrix for a given pair of variables selected by the user.

### State Space/Model View

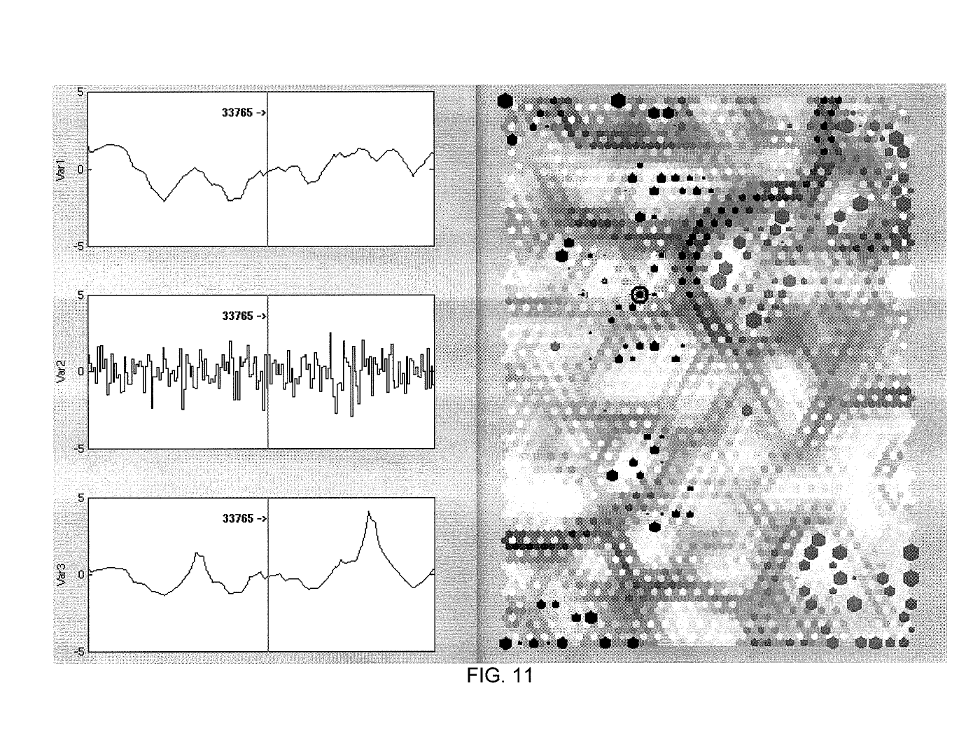

The Model View 44 shows a visualization of the state space, an example of which is shown in FIG. 11. In this example, the multi-dimensional process space has been reduced to a 2-dimensional representation. Each point represents a unique area of the operating environment of the process. There are three key performance indicators (KPIs) of the process, the production rate, the steam consumption and the cost per tonne of production. The area shown in blue in this screen (black hexagons in the diagram) shows the operating region where all three of the key performance indicators are achieved while the area in red (large grey hexagons in the diagram) shows the operating region where none of the KPIs are met. The black concentric “target” marker is the current operating state of the process. This information, together with the trajectory of the process set-points required to bring the process back into the desirable operating regime, allows the process to be always close to optimal.

The right panel shows the state space. The visualization is based on the SOM U-matrix. The left panel shows the values of selected variables. The temporal position of the operating point is indicated by the red bar in the left hand panel.

Operations available to the user include:
Shift the operating point in time, displaying the trajectory in the state space.
Select a state and display the time intervals corresponding to that process state.
Change the criteria for labeling states.

### EXAMPLES OF USE OF EMBODIMENTS OF THE INVENTION

A number of example research questions that the present invention may be used to address are described below. The list is not intended to be exclusive, but more to give an indication of the components that might be required and the interaction of the components.

### Case 1: Determine Conditions Relating to an Event

Which events (alarm or process condition) are related to this event?
Is there any similarity between a given pair of events?
Is there any similarity between this event and events occurring in other process areas?

### Analysis Steps

1. Define regions that have any significance (change of raw material, maintenance of equipment etc.)
2. Reject regions that are atypical (equipment shutdown etc)
3. Generate Correlation matrix
4. View results for maximum correlations with event of interest.
5. Determine input variables or events that have a significant correlation (85%) with the output variable of interest.

### Results

An insight into which inputs result in an event occurring, any recorded events that usually occur with a given event.

### Case 2: Rationalize Alarms

### Rationalize Alarms

eliminate alarms on non-critical events that are strongly correlated with other events.
Eliminate redundant non-critical alarms

### Analysis Steps

1. Define regions that have any significance (change of raw material, maintenance of equipment etc.)
2. Reject regions that are atypical (equipment shutdown etc)
3. Generate Correlation matrix
4. View results for maximum correlations with event of interest.
5. Determine input variables or events that have a significant correlation (85%) with the output variable of interest.

### Results

Elimination of redundant non-critical alarms and a more reliable and appropriate operator response to the remaining alarms.

### Case 3: Determine Input Variables Relating to Output Variable

What are the input variables that impact on my output variable?
What is the magnitude of the contribution of these variables to the variability in my variable?
What are the delays?

### Analysis Steps

1. Define the units
2. Define the variable categories
3. Import the data
4. Define stationary regions
5. Define regions that have any significance (change of raw material, maintenance of equipment etc.)
6. Reject regions that are atypical (equipment shutdown etc)
7. Generate Correlation matrix
8. View input/output results for maximum correlations
9. Determine input variables that have a significant correlation (>10%) with the output variable of interest.
10. View sensitivities to determine which input variables have the greatest impact on variability of the output variable of interest.
11. View the unit analysis to determine why.
12. View the unit(s) that are inputs to the unit of interest
13. Perform similar investigation on each of these units.
14. Repeat the above steps for any data regions that have different statistical properties then review the difference between data regions to determine whether there is any significant difference in performance between the regions.

### Results

Determine the following:
A range of manipulable and exogenous variables that impact on the variable of interest,
The sensitivity of the variable to each of the input variables,
An approximation of the changes in mean of these variables to achieve a particular value of the target variable,
The time delay in the response of the target variable to changes in the input variables, and
Any benefits that can be obtained from the different operating regimes that were identified as part of the data preparation.

### Case 4: Determine Impacts of a Variable

What are the variables that my variable impacts on?
What contribution does my variable make to the variability of these variables?
What are the delays?

### Analysis Steps

1. The investigation process is similar to above except that the progression is from input to output.

### Results

The impact of changes in the variable upon significant downstream variables.
Case 5: Determine when Key Performance Indicators are Met
My process is running well when the following KPIs are met.
Under what conditions does this occur?
Can I see how close I am to the operating envelope?

### Analysis Steps

1. Data preparation as before. In addition, define events for when each of the KPIs are within specification, out of specification (high and low) and extremes.
2. Reject data for the extremes as well as any abnormal situations.
3. Determine the significant manipulable and exogenous variables that impact on the KPIs.
4. Define events for when the input variables are outside ranges that allow the KPIs to be met.
5. Using all the data except that which is during times when abnormal situations are occurring, generate a reduced dimension spatial representation of the process space for the significant input variables and the KPIs
6. Feed live data into the spatial map.

### Results

Identification of the most significant variables that impact upon the process performance.
A real time visualization of the process that indicates the current, or future compliance of the process with the KPIs
An understanding of the margin for correcting the impact of exogenous variables with manipulable variables.
Identification of operating regimes that perform better than others.
   Case 6: Determine how to Restore a Process to within Specification
   My process is frequently out of specification. I have no control over some of the variables.
What changes can I make to restore it to within the specification?

### Analysis Steps

1. Data preparation as before. In addition, define events for when each of the KPIs are within specification, out of specification (high and low) and extremes.
2. Reject data for the extremes as well as any abnormal situations.
3. Determine the significant manipulable and exogenous variables that impact on the KPIs.
4. Define events for when the input variables are outside ranges that allow the KPIs to be met.
5. Using all the data except that which is during times when abnormal situations are occurring, generate a reduced dimension spatial representation of the process space for the significant input variables and the KPIs
6. Identify operating regions where the specifications are met.
7. Determine relationships between manipulable variables and exogenous variables in these regions.
8. Feed the spatial representations with live data so that the operator can determine when deviations from the acceptable operating region are occurring.
9. Take corrective action to return process to an acceptable operating region.

### Results

An understanding of what actions can be taken to compensate for changes in exogenous variables,
Ongoing visualization of the process, which defines regions of unacceptable operation.
Early warning of undesirable changes in exogenous variables.

### Case 7: Determine how to Avoid Alarms

Deviations in one of my process variables frequently cause an alarm.
Under what conditions does this occur?
Is there any action that I can take to avoid this alarm?
Can I visualize when this is likely to occur?

### Analysis Steps

1. The analysis process is similar to that used for defining relationships between variables in Case 3 except that in this case, the research interest is in an event.

### Results

A range of manipulable and exogenous variables that generate the event of interest,
The significance of each of the input variables to the generation of the event,
The time delay in the generation of the event after changes in the input variables,
Any benefits that can be obtained from the different operating regimes that were identified as part of the data preparation.

### Case 8: Compare Performance of Process Units

I have two supposedly identical process units but their performance is different.
Can I identify why these differences occur?

### Analysis Steps

1. Pre-process the data to eliminate atypical process operation.
2. Test the hypothesis that the two process operations are different.
3. Test the hypotheses that the exogenous inputs to the process are different. If they are, then the at least differences are due to factors external to the process unit.
4. Test the hypotheses that the manipulable inputs to the process are different.
5. Determine the relationships between the KPIs for each unit and the inputs to the unit.
6. Having determined that there is a difference in the units, test whether there are any statistical differences in the process states of the unit.

### Results

The reason for the differences should be identified in one of the analysis steps.

### Case 9: Compare Performance of Operator Shifts

I have a rotating 5-panel shift system.
Can I determine why production is better (or worse) with one crew than the other crews?

### Analysis Steps

1. The analysis of this problem is in many ways simpler than the previous problem. Given that there is data available over a sufficient period of time, any variability due to the exogenous variables or the actual process will be eliminated. The remaining group of variables are the manipulable variables, controlled by the operators.
2. The problem therefore reduces to determining whether there is any difference between the relationships between the manipulable variables, identified by shift and the KPIs for the process. If there is a statistical difference then identify which shift produces outcomes that are closer to the KPIs for the process

### Results

By identifying that there is a difference between shifts and which shift statistically produces outcomes closer to the KPIs, it is possible to improve the performance of the poorer performing shifts.

### Case 10: Analyze Operating States for a Process

How many different process states are in a particular process unit?
How to identify the process states for a set of process variables from that process unit?
How to adjust the set point of relevant process variables in order to bring the process states from bad to good?

### Analysis Steps

1. Select process variables that are of interest.
2. Collect process data from interested time periods and perform outlier filtering on each process variable.
3. Generate self-organizing map (SOM).
4. Label the regions identified by SOM with different process states. Identify the good and bad process states.
5. Check the process data plots and SOM to identify D when process state goes from good to bad.
6. SOM can identify the relevant process variables that need to be adjusted in order to bring the process states from bad to good. Adjust the set points of these process variables according to the differences identified by SOM.

### Results

Identify and recover from the bad process states which ensure the process is optimal and has maximum production.

### IMPLEMENTATION

The present invention is typically implemented in the form of one or more computer programs which control the operation of a computer. When loaded with the computer program and the program is executed the computer is able to perform the invention described above. A typical computer has one or more microprocessors which execute instructions of the computer program. The instructions of the computer program and the data of the invention reside in memory as required and are stored in a non-volatile storage device for longer term storage, e.g. a hard disk drive or networked storage. The computer further has an input device(s) for receiving input from a user e.g. a keyboard and mouse. The computer further has a visual display unit, such as a computer screen.

### BENEFITS OF THE INVENTION

The present invention attempts to handle information from industrial processes and other sources and provide the following primary functions:
Visualization. Due to the size and complexity of data in the process domain, it is difficult to interpret process information with existing tools. To make the system fast for interactive users, specific data structures are used to effectively analyze and render large volumes of information in real-time.
Modeling. The system attempts to discover relationships in process data that are meaningful to the process engineer. It uses correlation techniques to identify relationships between process variables, including situations where time lags are involved. It uses neural networks (e.g. SOMs) to model the “state space” of a process.
Classification. Given a process model, it is possible to qualitatively label the operating state of the process (e.g. as normal, abnormal, optimal, unproductive, etc).

The present invention attempts to seamlessly bring together a number of analysis and visualization tools that, in combination, allow a process engineer to explore an industrial process interactively at high speed. There is no practical restriction to the size of the data set that can be visualized and manipulated. It includes means to:
Perform statistical analysis of the data
Generate correlation matrices of the data
Determine lagged correlations
Perform dimensional reduction
Display 2 or 3 dimensional representation of the process space
Allow classification of operating regimes
Allow detection of abnormal operating regimes
Perform identification of missing or bad measurements

The PDMS is designed to assist process engineers in solving practical problems relating to plant operation and management. Its applications include the following:
Improve product quality by identifying manipulable variables that impact on quality while counteracting the impact of exogenous variables.
Stabilize process operation by identifying significant exogenous variables that must be monitored and responded to.
Improve response to deviations from an acceptable process trajectory as a result of human error or equipment failure.
Provide faster alarm response by identifying causes of alarm floods and identifying alarms that are significant for the process.
Provide improved process understanding by identifying relationships between manipulable variables and key performance indicators.
Provide Process Visualization on large and interconnected process units enabling the downstream consequences of operator actions or process deviations to be understood.
Identify complex relationships between large numbers of process variables and non-real-time data such as laboratory analyses and key performance indicators.
Analysis of control strategies by analyzing the relationships between controller outputs and key performance indicators for the process.

Modifications and variations may be made to the present invention without departing from the basic inventive concepts described herein. It will be understood to persons skilled in the art of the invention that many modifications may be made without departing from the spirit and scope of the invention. Such modifications and variations are intended to fall within the scope of the present invention.

What is claimed is:

1. A computer assisted method of analysis suitable for process control, comprising the steps of:
receiving first data streams representing values from a process;
receiving second data streams representing states of the process;
recording metadata about the data streams;
calculating relationships between pairs of the data streams;
recording relationship data resulting from the calculating step together with an association between at least one relationship datum and its corresponding meta-data.

2. A computer assisted method according to claim 1, wherein the data streams are discontinuous streams.

3. A computer assisted method according to claim 1, wherein the values of the first data streams are measurements from the process.

4. A computer assisted method according to claim 1, wherein the values of the first data streams are sampled over time.

5. A computer assisted method according to claim 1, wherein the states of the second data streams are events or conditions in the process.

6. A computer assisted method according to claim 1, wherein there are one or more third data streams representing statistics calculated from the first or second data streams, or both.

7. A computer assisted method according to claim 1, wherein the metadata concerns the origins of the data streams and the association links each datum to its respective locations of origin.

8. A computer assisted method according to claim 1, wherein the meta-data includes flow charts or plant diagrams.

9. A computer assisted method according to claim 8, wherein the chart or diagram displays value of each datum at the location of its source.

10. A computer assisted method according to claim 1, wherein the calculating step involves calculating correlations of the data streams.

11. A computer assisted method according to claim 10, wherein the calculating step involves calculating, for a range of different time lags, autocorrelations of the data streams.

12. A computer assisted method according to claim 10, wherein the calculating step involves calculating, for a range of different time lags, cross-correlation of pairs of data streams.

13. A computer assisted method according to claim 10, comprising the further step of creating sub-sets within the relationship data, wherein each sub-set comprises data having a value within the same predetermined range of values.

14. A computer assisted method according to claim 13, wherein each sub-sets comprises data having a correlation value within the same predetermined range of values.

15. A computer assisted method according to claim 13, wherein the predetermined range of values is a user selectable parameter.

16. A computer assisted method according to claim 1, comprising the further step, as time passes and more data is received, of performing the calculating step again.

17. A computer assisted method according to claim 1, comprising the further step, as time passes and more data is received, of performing the calculating step repeatedly in real time.

18. A computer assisted method according to claim 1, comprising the further step of displaying the relationship data in a first form as a matrix with a single datum in each cell of the matrix, wherein the relationship data calculated for each data stream appears in both a row and a column of the matrix.

19. A computer assisted method according to claim 18, wherein the matrix is convertible directly to raster.

20. A computer assisted method according to claim 18, wherein the rows and columns are grouped according to the value of the relationship data.

21. A computer assisted method according to claim 1, comprising the further step of displaying the relationship data in a second form as a diagram of metadata having locations marked according to their corresponding relationship datum.

22. A computer assisted method according to claim 21, comprising the further step of indicating in the diagram of metadata the location of the source of each data stream.

23. A computer assisted method according to claim 1, comprising the further step of displaying the relationship data in a third form as a list.

24. A computer assisted method according to claim 1, comprising the further step of displaying the data streams in the form of time-series data.

25. A computer assisted method according to claim 1, comprising the further step of displaying historical values of the relationship data or data streams.

26. A computer assisted method according to claim 1, comprising the further step of displaying correlations between a pair of data streams as a function of lagged time.

27. A computer assisted method according to claim 18, wherein coding is used to identify different sub-sets in the display.

28. A computer assisted method according to claim 27, wherein the coding is color coding or shading.

29. A computer assisted method according to claim 27, wherein a user is able to select a sub-set by:
clicking on a cell in the matrix;
clicking on a marked location in the meta-data diagram; or,
clicking on a datum in the list.

30. A computer assisted method according to claim 13, comprising the further step of switching between different forms of the displays claimed in claims 18 to 23.

31. A computer assisted method according to claim 30, comprising the further step of switching between different forms of the displays while preserving the same sub-set selected in the different forms.

32. A computer assisted method according to claim 18, comprising the further steps of changing the degree of cross-correlation, and changing the sub-sets displayed in response.

33. A computer assisted method according to claim 18, comprising the further steps of changing the time lag, and consequently changing the sub-set displayed.

34. A computer assisted method according to claim 1, wherein the method is used in the control of an Industrial Plant.

35. A computer assisted method according to claim 1, wherein a neural network is trained to model the state space of the process.

36. A computer system for performing process control analysis comprising:
a means for receiving first data streams representing values from a process;
a means for receiving second data streams representing states of the process;
a means for recording metadata about the data streams;
a means for calculating relationships between pairs of the data streams;
a means for recording relationship data resulting from the calculating step together with an association between at least one relationship datum and its corresponding meta-data.

37. Computer software embodied in a computer readable storage medium comprising instructions for causing a computer to:
receive first data streams representing values from a process;
receive second data streams representing states of the process;
record metadata about the data streams;
calculating relationships between pairs of the data streams;
record relationship data resulting from the calculating step together with an association between at least one relationship datum and its corresponding meta-data.
